(19) United States
(12) Patent Application Publication
(10) Pub. No.: US 2023/0368959 A1
(43) Pub. Date: Nov. 16, 2023

(54) MAGNETIC CORE AND MAGNETIC DEVICE

(71) Applicant: TDK CORPORATION, Tokyo (JP)

(72) Inventors: Kyotaro ABE, Tokyo (JP); Isao NAKAHATA, Tokyo (JP)

(73) Assignee: TDK CORPORATION, Tokyo (JP)

(21) Appl. No.: 18/315,581

(22) Filed: May 11, 2023

(30) Foreign Application Priority Data
May 16, 2022 (JP) 2022-080135

(51) Int. Cl. H01F 27/255; H01F 27/28; H01F 3/14

(52) U.S. Cl. CPC H01F 27/255; H01F 27/2823; H01F 3/14

(57) ABSTRACT

A magnetic core includes a first core and a second core. The first core includes a first opposing surface. The second core includes a second opposing surface. The first opposing surface and the second opposing surface are aligned so as to form at least a part of a closed magnetic circuit consisting of the first core and the second core. The first opposing surface and/or the second opposing surface has an arithmetic mean roughness Ra of 7 μm or more and less than 65 μm.

### BACKGROUND OF THE INVENTION

The present invention relates to a magnetic core used for a magnetic device, such as an inductor.

As a magnetic core, there is a magnetic core used by joining cores to prevent magnetic saturation with a gap provided between their opposing surfaces. In such a core, magnetic flux leakage generated in the gap passes through a coil, and eddy currents are generated in the coil. This heats the core and increases energy loss.

As a method for reducing the loss between the opposing surfaces of the cores, a method of changing the material as shown in Patent Document 1 is known. As shown in Patent Document 2, it is also known to have a new structure on the opposing surfaces. In these conventional techniques, however, fabrication of the core is complicated, and reproducibility is low. Although it is also proposed to obliquely arrange the opposing surfaces as shown in Patent Document 3 and to change the position of the gap as shown in Patent Document 4, these impose restrictions on the shape of the core, and the manufacturing method thereof is also limited.
Patent Document 1: JP2020053463 (A)
Patent Document 2: JP2016025273 (A)
Patent Document 3: JP2016072569 (A)
Patent Document 4: JP2021019003 (A)

### BRIEF SUMMARY OF THE INVENTION

The present invention has been achieved under such circumstances. It is an object of the invention to provide a magnetic core and a magnetic device capable of easily reducing core loss without significantly changing core material and structure.

To achieve the above object, a magnetic core according to the present invention comprises:
a first core including a first opposing surface; and
a second core including a second opposing surface,

wherein
the first opposing surface and the second opposing surface are aligned so as to form at least a part of a closed magnetic circuit consisting of the first core and the second core, and
the first opposing surface and/or the second opposing surface has an arithmetic mean roughness Ra of 7 μm or more and less than 65 μm.

As a result of intensive studies on magnetic cores capable of reducing core loss, the present inventors have found that the surface roughness of opposing surfaces of cores facing each other contributes to reduction in core loss and completed the present invention.

That is, in the magnetic core according to the present invention, core loss can be easily reduced without significantly changing core material and structure only by determining the surface roughness of opposing surfaces of cores facing each other in a specific range.

Also, variation in magnetic permeability can be reduced by determining the arithmetic mean roughness Ra of opposing surfaces in a specific range. Moreover, the reduction effect on core loss and the variation reduction in magnetic permeability are particularly exhibited at high frequencies.

Preferably, the first core and/or the second core comprises laminated soft magnetic alloy layers. When the magnetic core is made of a soft magnetic alloy, the reduction effect on core loss is greater than when the magnetic core is made of a ferrite.

Preferably, a gap is formed between the first opposing surface and the second opposing surface. When a gap is formed between the opposing surfaces, the reduction effect on core loss is particularly large.

Preferably, the gap is larger than the arithmetic mean roughness Ra of the first opposing surface and/or the second opposing surface. When the gap is larger than the arithmetic mean roughness Ra of the opposing surface, the reduction effect on core loss is particularly large.

The first core and the second core may include another opposing surfaces, respectively, at a position other than the gap, and the another opposing surfaces may be joined with a gap smaller than the gap formed between the first opposing surface and the second opposing surface.

A magnetic device according to the present invention comprises the magnetic core according to any of the above.

### BRIEF DESCRIPTION OF THE DRAWING(S)

FIG. 1A is a schematic cross-sectional view of a coil device including a magnetic core according to an embodiment of the present invention;

FIG. 1B is a schematic cross-sectional view of a coil device including a magnetic core according to another embodiment of the present invention; and

FIG. 2 is a schematic cross-sectional view of a main part along the line II-II shown in FIGS. 1A and 1s a figure in which both sides of a fracture surface along the X-axis are omitted by wavy lines.

### DETAILED DESCRIPTION OF THE INVENTION

Hereinafter, the present invention is described based on embodiments shown in the figures.

### First Embodiment

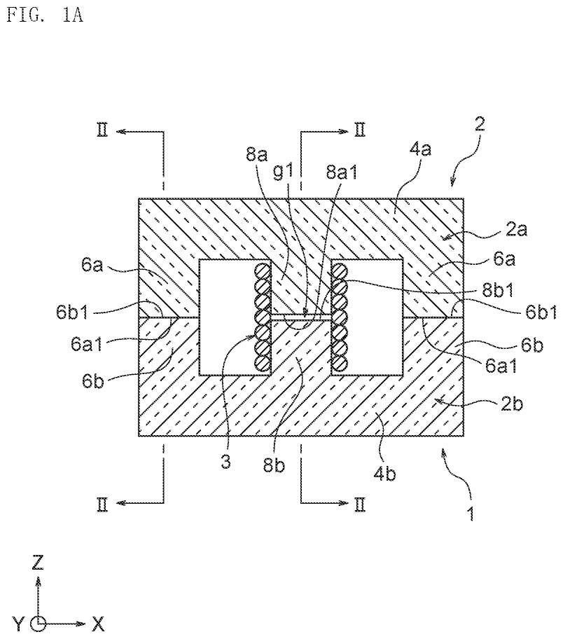

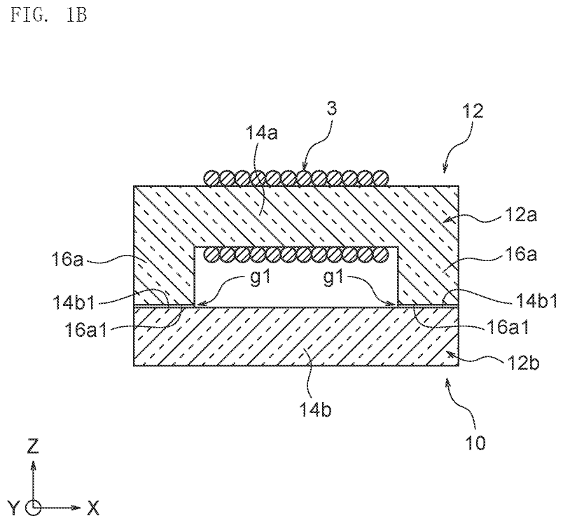

As shown in FIG. 1A, a coil device 1 including a magnetic core 2 according to an embodiment of the present invention is used as, for example, an inductor. The coil device 1 includes the magnetic core 2 and a wire 3 wound in a coil shape.

The magnetic core 2 includes a first core 2a and a second core 2b, and these cores are combined. Each of the cores 2a and 2b is referred to as an E-shaped core having an E-shaped cross section. In the figures, the X-axis, the Y-axis, and the Z-axis are perpendicular to each other.

Examples of the magnetic material constituting the cores 2a and 2b include a ferrite and a metallic magnetic material. Examples of the ferrite include a Ni—Zn based ferrite and a Mn—Zn based ferrite. The metallic magnetic material is not limited and may be, for example, a Fe base alloy including a main component represented by a composition formula of (Fe_{(1-(α+β)})X1_{α}X2_{β})_{(1-(a+b+c+d))}MₐB_{b}P_{c}Si_{d}, where X1 is one or more selected from the group consisting of Co and Ni, X2 is one or more selected from the group consisting of Al, Mn, Ag, Zn, Sn, As, Sb, Cu, Bi, S, N, O, and rare earth elements, M is one or more selected from the group consisting of Nb, Ta, W, Zr, Hf, Mo, Cr, and Ti, wherein 0≤a≤0.150, 0.010≤b≤0.200, 0.0005≤c≤0.150, 0.0005≤d≤0.180, α≥0, β≥0, and 0≤α+ƒβ≤0.50 are satisfied. The alloy having the above-mentioned composition may be in an amorphous state or may be in a state in which Fe base nanocrystals are precipitated in the amorphous. The core 2a and the core 2b are preferably made of the same magnetic material, but may be made of different magnetic materials.

Either of the cores 2a and 2b may be composed of a sintered body core, a dust core of an aggregate of magnetic particles dispersed in a resin, or a multilayer magnetic core in which magnetic layers are laminated.

The core 2a includes a base portion 4a having a flat plate shape substantially parallel to the X-axis and the Y-axis, outer leg portions 6a and 6a integrally formed at ends of the base portion 4a on both sides in the X-axis, and a middle leg portion 8a integrally formed substantially at the center of the base portion 4a in the X-axis. The middle leg portion 8a and the outer leg portions 6a and 6a protrude toward the same lower side in the Z-axis from the base portion 4a. However, the protrusion length of the middle leg 8a from the base portion 4a in the Z-axis is smaller than the protrusion length of the outer legs 6a and 6a from the base portion 4a in the Z axis.

Likewise, the core 2b includes a base portion 4b having a flat plate shape substantially parallel to the X-axis and the Y-axis, outer leg portions 6b and 6b integrally formed at ends of the base portion 4b on both sides in the X-axis, and a middle leg portion 8b integrally formed substantially at the center of the base portion 4b in the X-axis. The middle leg portion 8b and the outer leg portions 6b and 6b protrude toward the same lower side in the Z-axis from the base portion 4b. However, the protrusion length of the middle leg 8b from the base portion 4b in the Z-axis is smaller than the protrusion length of the outer legs 6b and 6b from the base portion 4b in the Z axis. Note that, each of the base portions 4a and 4b does not necessarily have a flat plate shape and may have an elongated bar shape in the X-axis.

A first opposing surface 8a1, which is a protruding tip surface of the middle leg portion 8a of the core 2a, and a second opposing surface 8b1, which is a protruding tip surface of the middle leg portion 8b of the core 2b, face each other with a predetermined gap g1. Third opposing surfaces 6a1 and 6a1, which are protruding tip surfaces of the outer leg portions 6a and 6a of the core 2a, and fourth opposing surfaces 6b1 and 6b1, which are protruding tip surfaces of the outer leg portions 6b and 6b of the core 2b, are butted and joined without substantial gaps. The third opposing surfaces 6a1 and 6a1 and the fourth opposing surfaces 6b1 and 6b1 are joined with an adhesive or the like.

For example, the wire 3 is wound in a coil shape in advance, and the middle leg portions 8a and 8b are inserted from both sides of the central through-hole of this coiled wire in the Z-axis direction so as to obtain the wire 3 wound around the middle leg portions 8a and 8b in a coil shape.

The wire 3 may be a conductive wire with an insulation coating or a conductive wire without an insulation coating. When a conductive wire without an insulation coating is used, preferably, the cores 2a and 2b are have an insulating property, or an insulating bobbin or the like is interposed between the cores 2a and 2b and the wire 3. The wire 3 may have a circular cross section or a rectangular cross section.

The shape of the horizontal cross section (cross section substantially parallel to the X-axis and Y-axis) of the middle leg portions 8a and 8b is not limited and may be circular, elliptical, or polygonal. This is also the case with the shape of the horizontal cross section of the outer leg portions 6a and 6b, and the shape of the horizontal cross section of the outer leg portions 6a and 6b is not limited.

The difference between the protrusion length of the middle leg portion 8a (8b) from the base portion 4a (4b) in the Z-axis and the protrusion length of the outer leg portions 6a and 6a (6b and 6b) from the base portion 4a (4b) in the Z axis is the gap g1. The gap g1 may be a space (air gap) in which nothing exists but air. Instead, a non-magnetic material, such as a resin filler (e.g., adhesive) and a resin film, may be interposed in the gap g1.

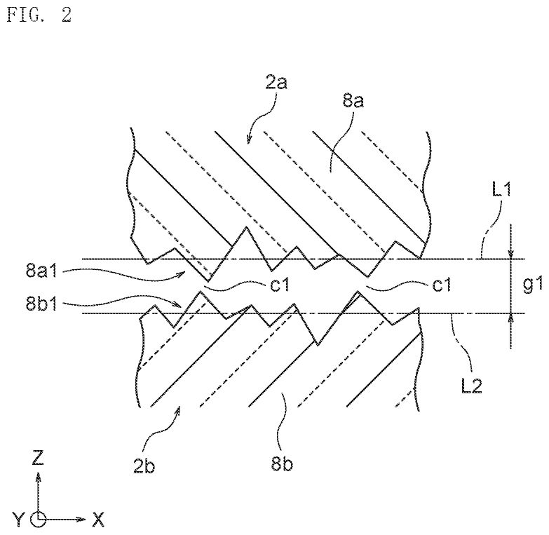

In the present embodiment, as shown in FIG. 2, at least either of the first opposing surface 8a1 and the second opposing surface 8b1 has an arithmetic mean roughness Ra of 7 μm or more and less than 65 preferably 15 to 63 more preferably 20 to 60 The other of the first opposing surface 8a1 and the second opposing surface 8b1 preferably has an arithmetic mean roughness Ra within the above-mentioned range, but may have an arithmetic mean roughness Ra of 7 μm or less. The arithmetic mean roughness Ra is measured based on JIS-B-0601:2001.

As shown in FIG. 2, the gap g1 between the first opposing surface 8a1 and the second opposing surface 8b1 can be defined as, for example, an average distance between an average line L1 of the arithmetic surface roughness Ra of the first opposing surface 8a1 and an average line L2 of the arithmetic surface roughness Ra of the second opposing surface 8b1. The gap g1 is preferably larger than the larger one among the arithmetic mean roughness Ra of the first opposing surface 8a1 and the arithmetic mean roughness Ra of the second opposing face 8b1 and is preferably, for example, about 1 to 20 times the arithmetic mean roughness Ra. The gap g1 is preferably 10 μm or more, more preferably 20 μm or more.

In general, the larger the gap g1 is, the smaller the magnetic permeability is. In the present embodiment, since the surface roughness of either of the opposing surfaces 8a1 and 8b1 is within a predetermined range, the reduction effect on core loss and the reduction effect on variations in magnetic permeability are greater than those in conventional examples having the same magnetic permeability and a surface roughness outside a predetermined range.

There is no limit to the arithmetic mean surface roughness Ra of the third opposing surfaces 6a1 and 6a1 of the outer leg portions 6a and 6a of the core 2a or the arithmetic mean surface roughness Ra of the fourth opposing surfaces 6b1 and 6b1 of the outer leg portions 6b and 6b of the core 2b. The third opposing surfaces 6a1 and 6a1 of the outer leg portions 6a and 6a of the core 2a and the fourth opposing surfaces 6b1 and 6b1 of the outer leg portions 6b and 6b of the core 2b are joined with a joint member (e.g., adhesive) that is sufficiently thinner than the gap g1 and can be said to be joined substantially without forming a gap.

Preferably, the third opposing surfaces 6a1 and 6a1 and the fourth opposing surfaces 6b1 and 6b1 have an arithmetic mean surface roughness Ra of 15 to 63 μm. This is to improve the joint between the third opposing surfaces 6a1 and 6a1 and the fourth opposing surfaces 6b1 and 6b1. Magnetic particles or the like may be contained in an adhesive for joining the third opposing surfaces 6a1 and 6a1 and the fourth opposing surfaces 6b1 and 6b1.

Examples of methods for controlling the surface roughness of the first opposing surface 8a1 of the middle leg portion 8a and the second opposing surface 8b1 of the middle leg portion 8b, where the gap g1 is formed, in a specific range include a polishing with abrasive papers having different mesh sizes, a blasting with blasting materials having different particle sizes, a cutting with blades, a perforating with needles, and a corrosion treatment with chemical impregnation. The gap g1 can be adjusted by reducing the length of the middle leg portion 8a in the Z-axis more than the length of the outer leg portions 6a and 6a in the Z-axis. Instead, the gap g1 can also be adjusted by reducing the length of the middle leg portion 8b in the Z-axis more than the length of the outer leg portions 6b and 6b in the Z-axis.

In the magnetic core 2 of the present embodiment, the core loss can be easily reduced without significantly changing core material and structure only by controlling the surface roughness of the first opposing surface 8a1 of the middle leg portion 8a and the second opposing surface 8b1 of the middle leg portion 8b, where the gap g1 is formed, within a specific range. The reason for this is not necessarily clear, but as shown in FIG. 2, this is probably because magnetic flux leakage can be reduced by interspersion of locations c1, where magnetic flux concentrates due to unevenness of the opposing surfaces 8a1 and 8b1 based on surface roughness, between the opposing surfaces 8a1 and 8b1, where the cores face each other. Examples of the locations c1, where magnetic flux concentrates, include locations where projections on the surfaces are close to each other and locations where a projection and the plane are close to each other.

Since the arithmetic mean roughnesses Ra of the opposing surfaces 8a1 and 8b1 are within a predetermined range, the variation in the magnetic permeability of the magnetic core 2 can also be reduced. Moreover, the reduction effect on core loss and the variation reduction in magnetic permeability are particularly exhibited at high frequencies of 1 MHz or more.

In the present embodiment, when the first core 2a and/or the second core 2b are/is formed of a laminated body of a plurality of laminated soft magnetic alloy layers, the reduction effect on core loss is greater than that when the first core 2a and/or the second core 2b are/is formed of ferrite.

### Second Embodiment

As shown in FIG. 1B, similarly to the above-described embodiment, a coil device 10 including a magnetic core 12 according to another embodiment of the present invention is used, for example, as an inductor. Except for the following matters, the coil device 10 has the same structure and exhibits the same effects.

The coil device 10 of the present embodiment includes the magnetic core 12 and a wire 3 wound in a coil shape. The magnetic core 12 includes a first core 12a and a second core 12b, and these cores are combined. The core 12a is referred to as a U-shaped core having a U-shaped cross section. Also, the core 12b is referred to as an I-shaped core having an I-shaped cross section. The magnetic core 12 of the present embodiment is a combination of an U-shaped core and an I-shaped core.

The core 12a includes a base portion 14a and outer leg portions 16a and 16a integrally formed at ends of the base portion 14a on both sides in the X-axis. The outer leg portions 16a and 16a protrude toward the same lower side in the Z-axis from the base portion 14a.

In the present embodiment, the wire 3 is wound in a coil shape in advance around the outer circumference of the base portion 14a, and the core 12a and the core 12b are thereafter combined. The core 12b is made of a base portion 14b having a flat plate shape or a bar shape and has no leg portions, but may be a U-shaped core similar to the core portion 12a.

First opposing surfaces 16a1 and 16a1 as protruding tip surfaces of the outer leg portions 16a and 16a of the core 12a and second opposing surfaces 14b1 and 14b1 of the core 12b face each other with a predetermined gap g1. In the present embodiment, the gap g1 can be adjusted by the thickness of, for example, an insulating film interposed between the first opposing surfaces 16a1 and 16a1 and the second opposing surfaces 14b1 and 14b1. The first opposing surfaces 16a1 and 16a1 and the second opposing surfaces 14b1 and 14b1 may be joined with an adhesive surface of the insulating film. Instead, the first opposing surfaces 16a1 and 16a1 and the second opposing surfaces 14b1 and 14b1 may face each other with a predetermined gap g1 by holding the core 12a and the core 12b with a different member such as a bobbin.

In the present embodiment, at least either of the first opposing surface 16a1 and the second opposing surface 14b1 has an arithmetic mean roughness Ra of 7 μm or more and less than 65 preferably 15 to 63 more preferably 20 to 60 The other of the first opposing surface 16a1 and the second opposing surface 14b1 preferably has an arithmetic mean roughness Ra within the above-mentioned range, but may have an arithmetic mean roughness Ra of 7 μm or less.

As a method for controlling the surface roughness of the first opposing surface 16a1 of the outer leg portion 16a and the second opposing surface 14b1 of the base portion 14a, where the gap g1 is formed, within a specific range, a similar method in the above-described embodiment may be used. As for the surfaces of the base portion 14a, at least the second opposing surface 14b1 has the surface roughness as described above. The surface of the base portion 14a of the second opposing surface 14b1 may have a surface roughness different from that of the second opposing surface 14b1 or may have the same surface roughness as the second opposing surface 14b1.

In the magnetic core 12 of the present embodiment as well, the core loss can be easily reduced without significantly changing core material and structure only by controlling the surface roughness of the first opposing surface 16a1 and the second opposing surface 14b1, where the gap g1 is formed, within a specific range.

Since the arithmetic mean roughness Ra of the opposing surfaces 16a1 and 14b1 is within a predetermined range, the variation in the magnetic permeability of the magnetic core 12 can also be reduced. Moreover, the reduction effect on core loss and the variation reduction in magnetic permeability are particularly exhibited at high frequencies of 1 MHz or more.

In the present embodiment as well, when the first core 2a and/or the second core 2b are/is formed of a laminated body of a plurality of laminated soft magnetic alloy layers, the reduction effect on core loss is greater than that when the first core 2a and/or the second core 2b are/is formed of ferrite.

The present invention is not limited to the above-mentioned embodiments and may variously be modified within the scope of the present invention.

For example, the magnetic core of the above-described embodiments is a combination of an E-shaped core and an E-shaped core or a combination of an U-shaped core and an I-shaped core, but is not limited thereto and may be a combination of a U-shaped core and a U-shaped core, a combination of a pot-shaped core and a flat-plate core, or a combination of other types of cores. Moreover, in the above-described embodiments, a closed magnetic circuit is formed by combining two cores, but a closed magnetic circuit may be formed by combining three or more cores.

When the magnetic core has two or more gaps g1, the wider gap g1 has a greater effect on the characteristics of the magnetic core, and it is thus sufficient that the arithmetic mean surface roughness of either of the opposing surfaces facing each other with the wider gap g1 satisfies the predetermined relation of the above-mentioned embodiments.

Examples of magnetic devices include inductors and, based on their characteristics, noise filters, choke coils, power supply chokes, and high frequency transformers.

### EXAMPLES

Hereinafter, the present invention is described based on more detailed examples, but the present invention is not limited to these examples.

### Example 1

As shown in FIG. 1B, a first core 12a wound with a wire 3 and a second core 12b were prepared. The first core 12a and the second core 12b were made of a magnetic material of Mn—Zn based ferrite. Each of the cores 12a and 12b was obtained by sintering a molded body obtained by molding ferrite particles into a predetermined shape in a mold. In order to obtain gaps having a uniform width in the surface direction, opposing surfaces 16a1 and 14b1 of the cores 12a and 12b were polished by a polishing apparatus (S5629 manufactured by Struers) so that an arithmetic mean surface roughness Ra would be 4 μm or less.

After that, the first opposing surfaces 16a1 were subjected to a surface treatment with an abrasive paper of #80 so as to intentionally roughen the surfaces. The second opposing surface 14b1 was maintained with a polished surface polished by the polishing apparatus. The arithmetic mean roughness Ra of the first opposing surfaces 16a1 was 7 μm, and the arithmetic mean roughness Ra of the second opposing surface 14b1 was 4 μm. The Ra was measured according to JIS-B-0601:2001 using a surface profiler Surfcoder ETA4000A manufactured by Kosaka Laboratory.

Next, the copper wire 3 with insulation coating was wound around a base portion 14a of the first core 12a by five turns, and the first core 12a and the second core 12b were combined with a gap g1 formed by interposing a PET film with a predetermined thickness between the first opposing surfaces 16a1 and the second opposing surface 14b1. For 10 samples of the coil device 12 manufactured in such a manner and randomly extracted, the gap g1 was adjusted by selecting a PET film with a constant thickness so that the average magnetic permeability would be 400 (within ±20). The magnetic permeability was measured at 1 MHz using an LCR meter. Also, a dispersion (standard deviation) σ of the magnetic permeability at this time was determined. Table 1 shows the results.

The gap g1 was determined by summing the half of the arithmetic mean roughness of the first opposing surfaces 16a1, the half of the arithmetic mean roughness of the second opposing surface 14b1, and the thickness of the PET film.

The obtained samples of the coil device 10 were measured for core loss using a BH analyzer at a frequency of 1 MHz and a magnetic flux density of 10 mT. Table 1 shows the results. In addition, a loss reduction rate was obtained by calculating how much the core loss in Example 1 was reduced when the core loss in Comparative Example 1 described below was assumed to be 100%. Table 1 shows the results.

### Comparative Example 1

Samples of the coil device were manufactured in the same manner as in Example 1, except that both of the arithmetic mean roughness Ra of the first opposing surfaces 16a1 and the arithmetic mean roughness Ra of the second opposing surface 14b1 were set to 4 μm by maintaining both of these surfaces in the state of surfaces polished by the polishing apparatus, and that the thickness of the PET film was adjusted so that the average magnetic permeability would be equivalent to that in Example 1. The same measurements as in Example 1 were performed on the obtained 10 samples. Table 1 shows the results. The PET film was thicker than that in Example 1.

### Comparative Example 2

Samples were manufactured in the same manner as in Comparative Example 1, except that the arithmetic mean roughness Ra of the first opposing surfaces 16a1 was set to 6 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Comparative Example 1.

### Example 2

Samples were manufactured in the same manner as in Example 1, except that the arithmetic mean roughness Ra of the first opposing surfaces was set to 15 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Example 1.

### Example 3

Samples were manufactured in the same manner as in Example 1, except that the arithmetic mean roughness Ra of the first opposing surfaces was set to 34 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Example 2.

### Example 4

Samples were manufactured in the same manner as in Example 1, except that the arithmetic mean roughness Ra of the first opposing surfaces was set to 54 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Example 3.

### Example 5

Samples were manufactured in the same manner as in Example 1, except that the arithmetic mean roughness Ra of the first opposing surfaces was set to 63 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Example 4.

### Comparative Example 3

Samples were manufactured in the same manner as in Example 1, except that the arithmetic mean roughness Ra of the first opposing surfaces was set to 68 μm by adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 1 shows the results. The PET film was thinner than that in Example 5.

<Evaluation 1>

In Examples 1 to 5, in which the arithmetic mean roughness Ra of the first opposing surfaces 16a1 was within a predetermined range, the core loss was reduced compared to that in Comparative Example 1 and Comparative Example 2. In particular, compared to Comparative Example 3, Examples 1 to 5 had less variation in magnetic permeability.

### Example 11

Samples were manufactured in the same manner as in Example 1, except that the first core 12a and the second core 12b were made of a magnetic material of a Fe—Si—Nb—B—Cu alloy laminate. The same measurements as in Example 1 were performed on the obtained samples. Table 1 shows the results. From Example 11, a loss reduction rate was obtained by calculating how much the core loss in Example 11 was reduced when the core loss in Comparative Example 11 described below was assumed to be 100%.

### Comparative Example 11

Samples were manufactured in the same manner as in Example 11, except that the arithmetic mean roughness Ra of the first opposing surfaces was set to 5 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Comparative Example 12

Samples were manufactured in the same manner as in Example 11, except that the arithmetic mean roughness Ra of the first opposing surfaces was set to 6 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Example 12

Samples were manufactured in the same manner as in Example 11, except that the arithmetic mean roughness Ra of the first opposing surfaces was set to 21 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Example 13

Samples were manufactured in the same manner as in Example 11, except that the arithmetic mean roughness Ra of the first opposing surfaces was set to 35 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Example 14

Samples were manufactured in the same manner as in Example 11, except that the arithmetic mean roughness Ra of the first opposing surfaces was set to 53 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Example 15

Samples were manufactured in the same manner as in Example 11, except that the arithmetic mean roughness Ra of the first opposing surfaces was set to 64 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

### Comparative Example 13

Samples were manufactured in the same manner as in Example 11, except that the arithmetic mean roughness Ra of the first opposing surfaces was set to 69 μm by adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 1 shows the results.

<Evaluation 2>

In Examples 11 to 15, in which the arithmetic mean roughness Ra was within a predetermined range, the core loss was reduced compared to that in Comparative Examples 11 and 12. In particular, compared to Comparative Example 13, Examples 11 to 15 had less variation in magnetic permeability.

### Example 21

Samples were manufactured in the same manner as in Example 1, except that the arithmetic mean roughness Ra of the second opposing surface was set to 7 μm by also performing a surface treatment on the second opposing surface and adjusting the particle size of the abrasive paper and the treatment time at the time of the surface treatment, and that the thickness of the PET film was adjusted so that the average magnetic permeability would be equivalent to that in Example 1. The same measurements as in Example 1 were performed on the obtained samples. Table 2 shows the results.

### Example 22

Samples were manufactured in the same manner as in Example 11, except that the arithmetic mean roughness Ra of the second opposing surface was set to 7 μm by also performing a surface treatment on the second opposing surface and adjusting the particle size of the abrasive paper and the treatment time at the time of the surface treatment, and that the thickness of the PET film was adjusted so that the average magnetic permeability would be equivalent to that in Example 11. The same measurements as in Example 11 were performed on the obtained samples. Table 2 shows the results.

### Example 23

Samples were manufactured in the same manner as in Example 13, except that the arithmetic mean roughness Ra of the second opposing surface was set to 35 μm by also performing a surface treatment on the second opposing surface and adjusting the particle size of the abrasive paper and the treatment time at the time of the surface treatment. The same measurements as in Example 13 were performed on the obtained samples. Table 1 shows the results.

### Example 24

Samples were manufactured in the same manner as in Example 15, except that the arithmetic mean roughness Ra of the second opposing surface was set to 64 μm by also performing a surface treatment on the second opposing surface and adjusting the particle size of the abrasive paper and the treatment time at the time of the surface treatment. The same measurements as in Example 15 were performed on the obtained samples. Table 1 shows the results.

### Example 25

Samples were manufactured in the same manner as in Example 15, except that the arithmetic mean roughness Ra of the second opposing surface was set to 34 μm by also performing a surface treatment on the second opposing surface and adjusting the particle size of the abrasive paper and the treatment time at the time of the surface treatment. The same measurements as in Example 15 were performed on the obtained samples. Table 1 shows the results.

<Evaluation 3>

In Example 21, the core loss was further reduced as compared with that in Example 1. In Example 22, the core loss was further reduced as compared with that in Example 11. The core loss in Example 23 was equivalent to that in Example 13, and the core loss in Examples 24 and 25 was equivalent to or lower than that in Example 15. That is, in particular, when the first opposing surface and the second opposing surface had a small arithmetic mean surface roughness Ra, the core loss became equivalent by setting the arithmetic mean surface roughness Ra within a predetermined range not only for the first opposing surface, but also for the second opposing surface.

<Evaluation 4>

Regarding the samples of Examples 1 to 5, Examples 11 to 15, Comparative Examples 1 to 3, and Comparative Examples 11 to 13, Table 3 shows the results of reduction rate for core loss measured in the same manner as described above by changing the frequency from 1 MHz to 3 MHz. As shown in Table 3, particularly in the high frequency region, the reduction rate for core loss was improved in Examples compared to that in Comparative Examples.

### Examples 31 to 33 and Comparative Example 31

Samples were manufactured in the same manner as in Example 1, except for performing a surface treatment on the first opposing surface and the second opposing surface, adjusting the particle size of the abrasive paper and the treatment time at the time of the surface treatment, adjusting the thickness of the PET film so that the arithmetic mean surface roughness Ra of the first opposing surface, the arithmetic mean surface roughness of the second opposing surface, and the gap g1 would be the values shown in Table 4, and failing to adjust the average magnetic permeability among Examples 31 to 33 and Comparative Example 31. Regarding the obtained samples, the variation in magnetic permeability was determined in the same manner as in Example 1. Table 4 shows the results.

### Examples 41 to 44 and Comparative Example 41

Samples were manufactured in the same manner as in Example 11, except for performing a surface treatment on the first opposing surface and the second opposing surface, adjusting the particle size of the abrasive paper and the treatment time at the time of the surface treatment, adjusting the thickness of the PET film so that the arithmetic mean surface roughness Ra of the first opposing surface, the arithmetic mean surface roughness of the second opposing surface, and the gap g1 would be the values shown in Table 4, and failing to adjust the average magnetic permeability among Examples 41 to 44 and Comparative Example 41. Regarding the obtained samples, the variation in magnetic permeability was determined in the same manner as in Example 11. Table 4 shows the results.

<Evaluation 5>

As shown in Table 4, regardless of the core material, particularly in the region where the gap was small, the variation in magnetic permeability tended to decrease as the gap increased. In Examples 31 to 33 and Comparative Example 31, it was difficult to adjust magnetic permeability among them due to small gap, and the core loss was not thus compared. Also, in Examples 41 to 44 and Comparative Example 41, it was difficult to adjust magnetic permeability among them due to small gap, and the core loss was not thus compared.

TABLE 1

| | | Arithmetic | Arithmetic | | | | |
|---|---|---|---|---|---|---|---|
| | | Mean | Mean | | | | |
| | | Roughness | Roughness | | Core Loss at | Loss | |
| | | Ra of | Ra of | | 1 MHz − | Reduction | Permeability |
| | | First Core | Second Core | Gap | 10 mT | Rate | Variation |
| | Core Material | (μm) | (μm) | (μm) | (kW/m3) | (%) | σ (n = 10) |
| Comp. Ex. 1 | ferrite (Mn—Zn) | 4 | 4 | 118 | 70 | — | 14 |
| Comp. Ex. 2 | ferrite (Mn—Zn) | 6 | 4 | 118 | 67 | 4 | 13 |
| Ex. 1 | ferrite (Mn—Zn) | 7 | 4 | 118 | 63 | 10 | 13 |
| Ex. 2 | ferrite (Mn—Zn) | 15 | 4 | 121 | 62 | 11 | 13 |
| Ex. 3 | ferrite (Mn—Zn) | 34 | 4 | 129 | 61 | 13 | 15 |
| Ex. 4 | ferrite (Mn—Zn) | 54 | 4 | 134 | 61 | 13 | 16 |
| Ex. 5 | ferrite (Mn—Zn) | 63 | 4 | 135 | 62 | 11 | 00 |
| Comp. Ex. 3 | ferrite (Mn—Zn) | 68 | 4 | 136 | 62 | 11 | 30 |
| Comp. Ex. 11 | alloy lamination (Fe—Si—Nb—B—Cu) | 5 | 4 | 43 | 79 | — | 14 |
| Comp. Ex. 12 | alloy lamination (Fe—Si—Nb—B—Cu) | 6 | 4 | 42 | 77 | 3 | 14 |
| Ex. 11 | alloy lamination (Fe—Si—Nb—B—Cu) | 7 | 4 | 42 | 70 | 11 | 14 |
| Ex. 12 | alloy lamination (Fe—Si—Nb—B—Cu) | 21 | 4 | 49 | 68 | 14 | 15 |
| Ex. 13 | alloy lamination (Fe—Si—Nb—B—Cu) | 35 | 4 | 56 | 67 | 15 | 15 |
| Ex. 14 | alloy lamination (Fe—Si—Nb—B—Cu) | 53 | 4 | 65 | 67 | 15 | 17 |
| Ex. 15 | alloy lamination (Fe—Si—Nb—B—Cu) | 64 | 4 | 70 | 68 | 14 | 19 |
| Comp. Ex. 13 | alloy lamination (Fe—Si—Nb—B—Cu) | 69 | 4 | 73 | 68 | 14 | 30 |

TABLE 2

| | | Arithmetic | Arithmetic | | | |
|---|---|---|---|---|---|---|
| | | Mean | Mean | | | |
| | | Roughness | Roughness | Core Loss at | Loss | |
| | | Ra of | Ra of | 1 MHz − | Reduction | Permeability |
| | | First Core | Second Core | 10 mT | Rate | Variation |
| | Core Material | (μm) | (μm) | (kW/m3) | (%) | σ (n = 10) |
| Ex. 1 | ferrite (Mn—Zn) | 7 | 4 | 63 | 10 | 13 |
| Ex. 21 | ferrite (Mn—Zn) | 7 | 7 | 62 | 10 | 14 |
| Ex. 11 | alloy lamination (Fe—Si—Nb—B—Cu) | 7 | 4 | 70 | 11 | 14 |
| Ex. 22 | alloy lamination (Fe—Si—Nb—B—Cu) | 7 | 7 | 69 | 13 | 14 |
| Ex. 13 | alloy lamination (Fe—Si—Nb—B—Cu) | 35 | 4 | 67 | 15 | 15 |
| Ex. 23 | alloy lamination (Fe—Si—Nb—B—Cu) | 35 | 35 | 67 | 15 | 16 |
| Ex. 15 | alloy lamination (Fe—Si—Nb—B—Cu) | 64 | 4 | 68 | 14 | 19 |
| Ex. 24 | alloy lamination (Fe—Si—Nb—B—Cu) | 64 | 64 | 67 | 15 | 20 |
| Ex. 25 | alloy lamination (Fe—Si—Nb—B—Cu) | 64 | 34 | 68 | 14 | 19 |

TABLE 3

| | | Arithmetic | Arithmetic | | Loss | |
|---|---|---|---|---|---|---|
| | | Mean | Mean | Loss | Reduction | |
| | | Roughness | Roughness | Reduction | Rate | |
| | | Ra of | Ra of | Rate 1 MHz − | at 3 MHz − | Permeability |
| | | First Core | Second Core | 10 mT | 10 mT | Variation |
| | Core Material | (μm) | (μm) | (%) | (%) | σ(n = 10) |
| Comp. Ex. 1 | ferrite (Mn—Zn) | 4 | 4 | — | — | 14 |
| Comp. Ex. 2 | ferrite (Mn—Zn) | 6 | 4 | 4 | 7 | 13 |
| Ex. 1 | ferrite (Mn—Zn) | 7 | 4 | 10 | 11 | 13 |
| Ex. 2 | ferrite (Mn—Zn) | 15 | 4 | 11 | 13 | 13 |
| Ex. 3 | ferrite (Mn—Zn) | 34 | 4 | 13 | 14 | 15 |
| Ex. 4 | ferrite (Mn—Zn) | 54 | 4 | 13 | 14 | 16 |
| Ex. 5 | ferrite (Mn—Zn) | 63 | 4 | 11 | 12 | 18 |
| Comp. Ex. 3 | ferrite (Mn—Zn) | 68 | 4 | 11 | 12 | 30 |
| Comp. Ex. 11 | alloy lamination (Fe—Si—Nb—B—Cu) | 5 | 4 | — | — | 14 |
| Comp. Ex. 12 | alloy lamination (Fe—Si—Nb—B—Cu) | 6 | 4 | 3 | 8 | 14 |
| Ex. 11 | alloy lamination (Fe—Si—Nb—B—Cu) | 7 | 4 | 11 | 13 | 14 |
| Ex. 12 | alloy lamination (Fe—Si—Nb—B—Cu) | 21 | 4 | 14 | 15 | 15 |
| Ex. 13 | alloy lamination (Fe—Si—Nb—B—Cu) | 35 | 4 | 15 | 16 | 15 |
| Ex. 14 | alloy lamination (Fe—Si—Nb—B—Cu) | 53 | 4 | 15 | 16 | 17 |
| Ex. 15 | alloy lamination (Fe—Si—Nb—B—Cu) | 64 | 4 | 14 | 15 | 19 |
| Comp. Ex. 13 | alloy lamination (Fe—Si—Nb—B—Cu) | 69 | 4 | 14 | 15 | 30 |

TABLE 4

| | | Arithmetic Mean | Arithmetic Mean | | |
|---|---|---|---|---|---|
| | | Roughness Ra of | Roughness Ra of | | Permeability |
| | | First Core | Second Core | Gap | Variation |
| | Core Material | (μm) | (μm) | (μm) | σ(n = 10) |
| Comp. Ex. 31 | ferrite (Mn—Zn) | 4 | 4 | 9 | 15 |
| Ex. 31 | ferrite (Mn—Zn) | 7 | 4 | 10 | 14 |
| Ex. 32 | ferrite (Mn—Zn) | 15 | 15 | 20 | 13 |
| Ex. 33 | ferrite (Mn—Zn) | 34 | 15 | 30 | 13 |
| Comp. Ex. 41 | alloy lamination (Fe—Si—Nb—B—Cu) | 4 | 4 | 9 | 16 |
| Ex. 41 | alloy lamination (Fe—Si—Nb—B—Cu) | 7 | 4 | 10 | 15 |
| Ex. 42 | alloy lamination (Fe—Si—Nb—B—Cu) | 21 | 4 | 13 | 15 |
| Ex. 43 | alloy lamination (Fe—Si—Nb—B—Cu) | 35 | 4 | 20 | 14 |
| Ex. 44 | alloy lamination (Fe—Si—Nb—B—Cu) | 63 | 4 | 34 | 14 |

### DESCRIPTION OF THE REFERENCE NUMERICAL

1, 10 . . . coil device
2, 12 . . . magnetic core
2a, 12a . . . first core
2b, 12b . . . second core
4a, 4b, 14a, 14b . . . base portion
6a, 6b, 16a . . . outer leg portion
6a1, 6b1, 8a1, 8b1, 14b1, 16a1 . . . opposing surface
8a, 8b . . . middle leg portion
g1 . . . gap

What is claimed is:

1. A magnetic core comprising:
a first core including a first opposing surface; and
a second core including a second opposing surface,
wherein
the first opposing surface and the second opposing surface are aligned so as to form at least a part of a closed magnetic circuit consisting of the first core and the second core, and
the first opposing surface and/or the second opposing surface has an arithmetic mean roughness Ra of 7 μm or more and less than 65 μm.

2. The magnetic core according to claim 1, wherein the first core and/or the second core comprises laminated soft magnetic alloy layers.

3. The magnetic core according to claim 1, wherein a gap is formed between the first opposing surface and the second opposing surface.

4. The magnetic core according to claim 3, wherein the gap is larger than the arithmetic mean roughness Ra of the first opposing surface and/or the second opposing surface.

5. The magnetic core according to claim 4, wherein
the first core and the second core include another opposing surfaces, respectively, at a position other than the gap, and
the another opposing surfaces are joined with a gap smaller than the gap formed between the first opposing surface and the second opposing surface.

6. A magnetic device comprising the magnetic core according to claim 1.
